(19) United States
(12) Patent Application Publication
(10) Pub. No.: US 2021/0001398 A1
(43) Pub. Date: Jan. 7, 2021

(54) INSTALLATION STRUCTURE FOR NOZZLE/PLUG SEATING BLOCK

(71) Applicant: KROSAKIHARIMA CORPORATION, Fukuoka (JP)

(72) Inventors: Kouji KAWARADA, Fukuoka (JP); Kouichi TACHIKAWA, Fukuoka (JP)

(73) Assignee: KROSAKIHARIMA CORPORATION, Fukuoka (JP)

(21) Appl. No.: 16/978,270

(22) PCT Filed: Feb. 13, 2019
(86) PCT No.: PCT/JP2019/005132

§ 371 Date: Sep. 4, 2020

(30) Foreign Application Priority Data
Mar. 6, 2018 (JP) 2018-039894

(51) Int. Cl. B22D 41/56

(52) U.S. Cl. CPC B22D 41/56

(57) ABSTRACT

Provided is a sealing block installation structure capable of preventing the occurrence of a gap between a nozzle or plug installed in a bottom portion of a molten metal vessel and a plate or the like located on the lower side of the nozzle or plug, and a gap between the nozzle or plug and a sealing block located on the upper side of or on the outer peripheral side of the nozzle or plug. In the seating block installation structure, a seating block 2 disposed to surround a nozzle for discharging therethrough molten metal downwardly from the bottom portion of the molten metal vessel or a plug is fixed to a shell of the bottom portion of the molten metal vessel by a connecting member 3.

### TECHNICAL FIELD

The present invention relates to an installation structure for a seating block disposed to surround a nozzle for discharging therethrough molten metal downwardly from a bottom portion of a molten metal vessel, or a plug.

### BACKGROUND ART

A nozzle to be installed to a bottom portion of a molten metal vessel to discharge therethrough molten metal downwardly from the bottom portion of the molten metal vessel includes a plate-shaped sliding nozzle device, an immersion nozzle, and an upper nozzle.

For example, an upper plate of the sliding nozzle device is fixed to a shell of the bottom portion of the molten metal vessel, and the upper nozzle to be provided on the upper side of the upper plate is installed to the upper plate through a joint, and further installed to a seating block as a part of a refractory layer on the inner side of the shell of the bottom portion of the molten metal vessel, such that they come into direct contact with each other through a joint.

In the above installation structure, the joint defining a boundary areas between a lower end of the upper nozzle and the upper plate is formed such that it has a given thickness and tightly adheres to each of the lower end of the upper nozzle and the upper plate. However, this joint can separate or peel off from the lower end of the upper nozzle or the upper plate during use, and a distance therebetween is gradually increased to form a gap therebetween.

Further, the joint defining a boundary area between the upper nozzle and the seating block can also separate or peel off from the upper nozzle or the seating block, and a distance therebetween is gradually increased to form a gap therebetween.

If such a gap is formed, molten metal is likely to intrude into the gap and thus cause the occurrence of accidental spillage of molten metal.

With a view to suppressing the formation of such a gap in the boundary area between the upper nozzle and the upper plate or between the upper nozzle and the seating block, it has been tried to take measures mainly with respect to the upper nozzle.

For example, in the following Patent Document 1, there is disclosed “an upper nozzle for a sliding gate, which is formed in a hollow truncated cone shape whose outer peripheral surface has a taper angle of less than 7°, wherein the upper nozzle has a positioning protrusion which is provided on an outer periphery of a lower end thereof located just above the sliding gate, and configured to be hooked onto an outer wall or a refractory member of a lower portion of a molten metal holding vessel such as a tundish or a ladle” (see Abstract of the Patent Document 1). Further, in the following Patent Document 2, there is disclosed “a casting nozzle structure comprising: an upper nozzle 20 having a truncated cone-shaped upper portion and a cylindrical-shaped lower portion, and having a nozzle hole formed along an axial center to allow molten metal to pass therethrough; and a nozzle seating brick which is provided in a bottom portion of a molten metal vessel and into which the upper nozzle 20 is inserted from therebelow, wherein a sliding-type flow control device (slide valve) 4 is disposed on the lower side of the upper nozzle, and wherein an outer peripheral surface of the upper nozzle, except for a lower end thereof, is formed with a concave portion 21 and/or a convex portion 24” (see Abstract of the Patent Document 2).

In a plug which is installed inside a seating block for the purpose of, e.g., injecting gas into a molten metal vessel or applying current to the inside of the molten metal vessel, there is a possibility that a gap is formed with respect to the seating block or a shell, as with the aforementioned upper nozzle. This is highly likely to lead to accidental spillage of molten metal.

### CITATION LIST

### Parent Document

Patent Document 1: JP H11-207457A

Patent Document 2: JP 2002-035926A

### SUMMARY OF INVENTION

### Technical Problem

In the Patent Document 1, the “positioning protrusion configured to be hooked onto an outer wall or a refractory member of a lower portion of a molten metal holding vessel” can suppress a situation where the upper nozzle itself is displaced upwardly with respect to the shell or the like of the molten metal vessel. However, the upper nozzle is not fixed with respect to the seating block, and there is no feature to fix the seating block. Thus, if the seating block is displaced upwardly, the upper nozzle becomes relatively displaceable with respect to the seating block, and therefore a gap is inevitably formed therebetween.

Here, the mechanism of the formation of a gap will be described with reference to FIG. 17.

As shown in FIG. 17, in a conventional sealing block installation structure, a sealing block 2 is not directly fixed to a shell 4 of a bottom portion of a molten metal vessel. Due to heat or the like, a refractory lining layer of the bottom portion of the molten metal vessel including the seating block 2 is likely to be displaced with respect to the shell 4 of the bottom portion of the molten metal vessel, in an inward direction of the molten metal vessel, i.e., upwardly. In this case, along with this displacement, the seating block 2 is easily displaced in the inward direction of the molten metal vessel (upwardly), so that a gap 9 is formed with respect to the shell 4 of the bottom portion of the molten metal vessel.

On the other hand, an upper nozzle 1 becomes displaceable with respect to a lower-side member 7 (in this example, an upper plate) located on the lower side of the upper nozzle 1. That is, the upper nozzle 1 is installed such that a contact area (joint area) thereof with respect to the sealing block 2 is greater than a contact area thereof with respect to the lower-side member 7, and it is often the case that, due to infiltration of or reaction with slag and scale, a strongly-integrated region is formed between the seating block 2 and an upper portion of the upper nozzle 1. Thus, the upper nozzle 1 is displaced upwardly in conjunction with the seating block 2, while separating from the lower-side member 7, so that a gap 6 is formed with respect to the lower-side member 7.

As another measure against such a gap, the present inventors tried to use a structure in which an upper nozzle is locked by a metal component of a sliding nozzle device located outside a shell and on the lower side of the upper nozzle. However, in this case, when the upper nozzle is raised together with a seating block, the metal component is deformed or the upper nozzle is broken in the vicinity of the metal component, resulting in failing to prevent the occurrence of a gap between the upper nozzle and an upper plate.

In the Parent Document 2, the concave portion or the convex portion provided in the outer peripheral surface of the upper nozzle, except for the lower end thereof, can prevent relative displacement of the upper nozzle with respect to mortal. In particularly, a configuration in which the outer peripheral surface of the upper nozzle is formed with the convex portion which bites into an inner surface of the seating block can suppress a situation where the upper nozzle is displaced upwardly with respect to the seating block. However, in the Patent Document 2, there is also no feature to fix the seating block as mentioned in connection with the Patent Document 1 and FIG. 5, so that, if the seating block itself is displaced upwardly, the upper nozzle will be displaced in conjunction with the seating block, so that a gap is inevitably formed with respect to a plate or the like located on the lower side of the upper nozzle.

The above phenomenon can occur not only in the above nozzle, but also in a plug installed inside a sealing plate for the purpose of, e.g., injecting gas into a molten metal vessel or applying current to the inside of the molten metal vessel.

A technical problem to be solved by the present invention is to provide a sealing block installation structure capable of preventing the occurrence of a gap between a nozzle or plug installed in a bottom portion of a molten metal vessel and a plate or the like located on the lower side of the nozzle or plug, and a gap between the nozzle or plug and a sealing block located on the upper side of or on the outer peripheral side of the nozzle or plug, thereby preventing entrainment of air via the gaps and the occurrence of accidental spillage of molten metal.

### Solution to Technical Problem

The present invention provides a sealing block installation structure having features described in the following sections 1 to 7.

1. An installation structure for a seating block disposed to surround a nozzle for discharging therethrough molten metal downwardly from a bottom portion of a molten metal vessel, or a plug, wherein the seating block is fixed to a shell of the bottom portion of the molten metal vessel by a connecting member.

2. The installation structure as described in the section 1, wherein a joined portion of the connecting member to the shell has one or more selected from the group consisting of a welded structure, a thread engagement structure, and a contact structure between the connecting member and an outer surface of the shell defining a periphery of an opening of a through-hole penetrating through the shell.

3. The installation structure as described in the section 1 or 2, wherein a contact portion of the connecting member with the seating block is at least partly in contact with the seating block through one selected from the group consisting of a metal plate, a metal casing, and a sheet consisting mainly of an inorganic material or carbon.

4. The installation structure as described in any one of the sections 1 to 3, wherein the connecting member is composed of a plurality of independent members, wherein the independent members are configured to connect between the seating block and the shell, in a manner allowing assembling and disassembling by means of one or more selected from the group consisting of a thread engagement structure, a hooking structure, a fitting structure, a sliding structure, and a bayonet structure.

5. The installation structure as described in any one of the sections 1 to 4, wherein a joining portion of the connecting member exists in a manner distributed at least two positions equally dividing an outer periphery of the seating block.

6. The installation structure as described in any one of the sections 1 to 5, which is configured such that at least a part of the connecting member is covered so as not to be exposed to outside.

7. The installation structure as described in any one of the sections 1 to 6, which is configured such that an unshaped refractory material is provided in at least a part of a region on an upper or outer peripheral side of the connecting member.

### Effect of Invention

As a typical conventional technique, there has been known a fixing method based on a structure configured to clamp the seating block by a refractory layer provided around the periphery of the seating block, which becomes a primary factor causing the occurrence of displacement of the seating block in the inward (upward) direction of the molten metal vessel, and a gap with respect to the shell or the like. In particular, differently from the structure configured to clamp the seating block by the refractory layer provided around the periphery of the seating block, the seating block installation structure of the present invention is configured such that the seating block is fixed to the shell of the bottom portion of the molten metal vessel by the connecting member, so that the seating block becomes free from being displaced toward the inward side of the molten metal vessel in conjunction with the behavior of the refractory layer provided around the periphery of the seating block.

Thus, the nozzle such as an upper nozzle, or the plug, installed in an inner bore of the seating block, becomes free from being displaced upwardly with respect to nozzle/plug fixing means located outside the shell, such as an upper plate provided on the lower side of the nozzle or plug, so that it is possible to prevent the occurrence of a gap therebetween, or prevent entrainment of air into an inner bore of the nozzle and the occurrence of accidental spillage of molten metal.

Further, in the present invention, there is no need to weld a connecting member made of iron to the shell of the molten metal vessel, or, even in case of performing such a welding operation, there is no need to repeat the welding operation, i.e., the number of the welding operations can be minimized, so that it is possible to significantly suppress or prevent degradation or the like of the shell, thereby avoiding a risk of damage/breaking of the shell, and contribute to shortening, simplification and reduction of a maintenance time period, a maintenance process and a cost, necessary for welding and disassembling.

### BRIEF DESCRIPTION OF DRAWINGS

FIG. 1 is a vertical sectional view schematically showing a seating block installation structure according to a first embodiment of the present invention.

FIG. 2 is a vertical sectional view schematically showing a seating block installation structure according to a second embodiment of the present invention.

FIG. 3 is a vertical sectional view schematically showing a seating block installation structure according to a third embodiment of the present invention.

FIG. 4 is a vertical sectional view schematically showing one example of a modification of the seating block installation structure according to the third embodiment.

FIG. 5(a) is a vertical sectional view schematically showing a seating block installation structure according to a fourth embodiment of the present invention.

FIG. 5(b) is a vertical sectional view schematically and enlargedly showing one example of a modification of an area A in FIG. 5(a).

FIG. 6(a) is a top plan view schematically showing a seating block installation structure according to a fifth embodiment of the present invention.

FIG. 6(b) is a vertical sectional view schematically showing the seating block installation structure in FIG. 6(a).

FIG. 7(a) is a top plan view schematically showing one example of a modification of the seating block installation structure according to the fifth embodiment.

FIG. 7(b) is a vertical sectional view schematically showing the modification in FIG. 7(a).

FIG. 8(a) is a top plan view schematically showing another example of the modification of the seating block installation structure according to the fifth embodiment.

FIG. 8(b) is a vertical sectional view schematically showing the modification in FIG. 8(a).

FIG. 9(a) is a top plan view schematically showing yet another example of the modification of the seating block installation structure according to the fifth embodiment.

FIG. 9(b) is a vertical sectional view schematically showing the modification in FIG. 9(a).

FIG. 10 is a vertical sectional view schematically showing still another example of the modification of the seating block installation structure according to the fifth embodiment.

FIG. 11 is a top plan view schematically showing yet still another example of the modification of the seating block installation structure according to the fifth embodiment.

FIG. 12 is a vertical sectional view schematically showing a substantial part of another further example of the modification of the seating block installation structure according to the fifth embodiment.

FIG. 13 is a top plan view schematically showing one example of installation positions of connecting members.

FIG. 14 is a top plan view schematically showing another example of the installation positions of the connecting members.

FIG. 15 is a top plan view schematically showing yet another example of the installation positions of the connecting members.

FIG. 16 is a top plan view schematically showing still another example of the installation positions of the connecting members.

FIG. 17 is a vertical sectional view schematically showing a seating block installation structure in a state in which a conventional problem occurs, by taking an upper nozzle as an example.

### DESCRIPTION OF EMBODIMENTS

With reference to the drawings, the present invention will now be described based on various embodiments thereof.

A seating block installation structure according to a first embodiment of the present invention will be described with reference to FIG. 1.

In the first embodiment, a seating block 2 has a horizontally protruding portion at a lower end thereof, wherein the protruding portion is formed with a through-hole extending vertically. Further, a shell 4 of a bottom portion of a molten metal vessel has an internally threaded hole (hereinafter referred to as “screw hole”) at a position corresponding to the through-hole. The seating block 2 is fixed to the shell 4 by a connecting member (bolt) 3 having an externally threaded structure, in other words, screwed structure, conforming to the through-hold of the seating block 2 and the screw hole of the shell 4.

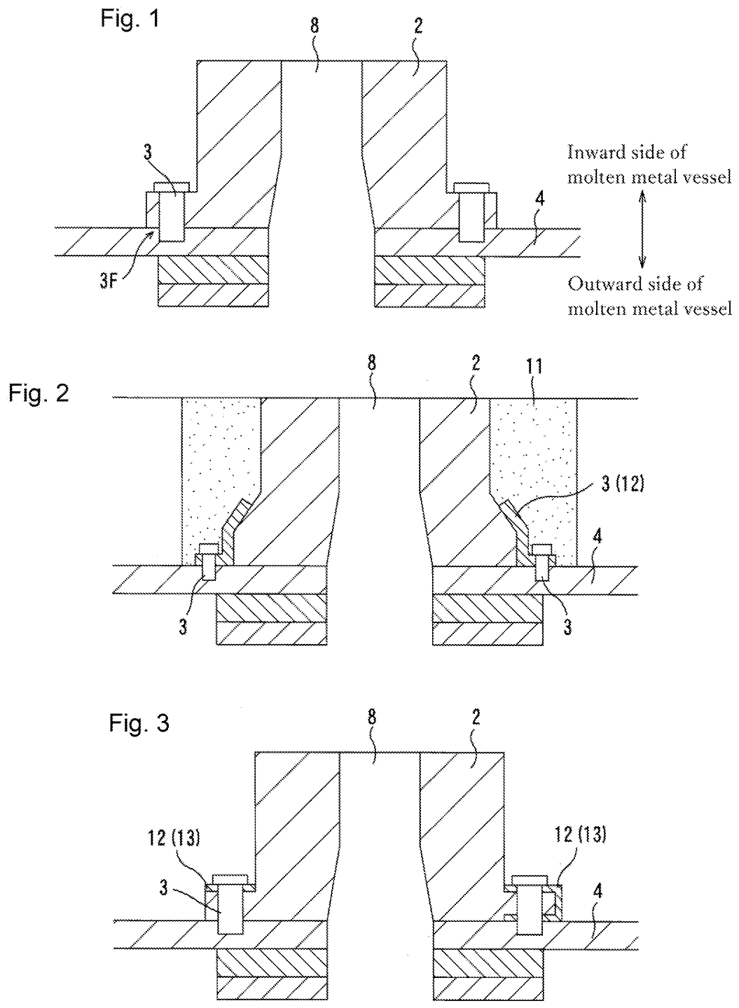

A seating block installation structure according to a second embodiment of the present invention will be described with reference to FIG. 2.

In the second embodiment, a seating block 2 has a downwardly expanding portion at a lower end thereof. A first connecting member 3 made of metal (a metal plate or metal casing 12) formed with a through-hole extending vertically is installed to constrain (hook) the expanding portion of the seating block 2 downwardly. Further, a shell 4 of a bottom portion of a molten metal vessel has a screw (internally threaded) hole at a position corresponding to the through-hole. The seating block 2 is fixed to the shell 4 by a second connecting member (bolt) 3 having an externally threaded structure conforming to the through-hold of the first connecting member 3 (the metal plate or metal casing 12) and the screw hole of the shell 4.

Further, in the second embodiment, after installation and fixing of the seating block, an unshaped refractory material 11 is formed on an upper and/or outer peripheral sides of the first and second connecting members 3.

A seating block installation structure according to a third embodiment of the present invention will be described with reference to FIG. 3.

The seating block installation structure according to the third embodiment is based on the seating block installation structure according to the first embodiment, and additionally configured such that a metal plate or sheet 12, or a sheet 13 consisting mainly of an inorganic material or carbon, is installed between the connecting member 3 and the seating block 2, or between the connecting member 3 and each of the seating block 2 and the shell 4, wherein the seating block 2 and the shell 4 are fixed together by the connecting member 3 through the metal plate or sheet 12 or the sheet 13.

The metal plate or sheet 12 or the sheet 13 consisting mainly of an inorganic material or carbon functions to relax local stress concentration or the like in a contact region of the seating block 2 with the connecting member 3 or the shell 4, thereby preventing breaking of the seating block 2.

A material and the like of the metal plate or sheet 12 may be appropriately selected depending on the temperature of the metal plate or sheet 12 during casting operation. In a case where the metal plate or sheet 12 is used in a molten steel or molten iron vessel, it may be made of commonly-used iron or stainless steel.

A material and the like of the sheet 13 consisting mainly of an inorganic material or carbon may also be appropriately selected depending on the temperature of the sheet 13 during casting operation. In a case where the sheet 13 is used in a molten steel or molten iron vessel, it may be made of an inorganic material such as commonly-used “alkaline earth silicate fiber (AES)” or so-called “RCF (refractory ceramic fiber)”, or a material consisting mainly of carbon such as graphite or carbon-based fibers.

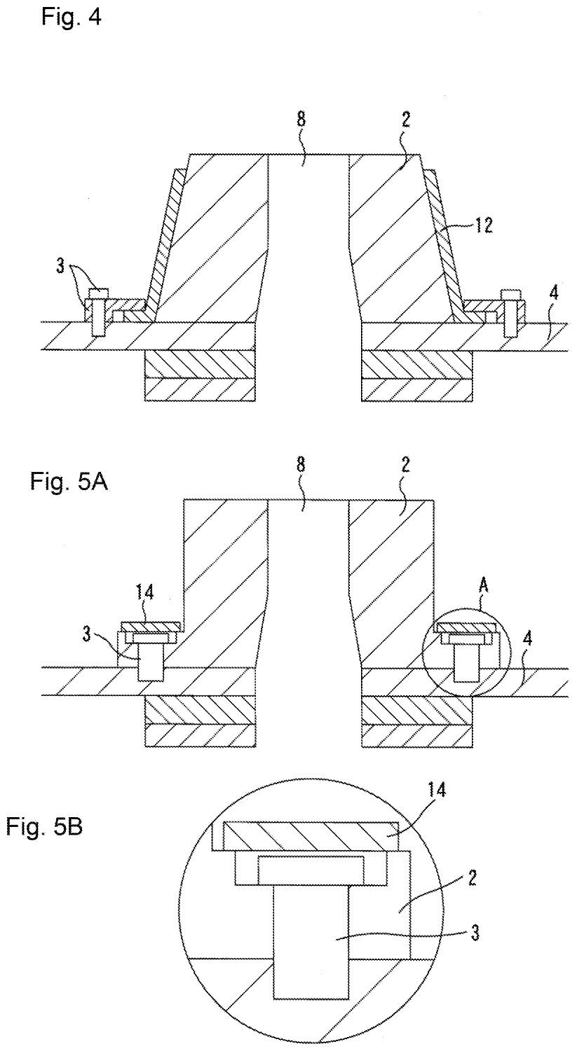

The metal plate or sheet 12 or the sheet 13 consisting mainly of an inorganic material or carbon may be used in such a manner that it surrounds a part of the seating block, or may be used in such a manner that it is sandwiched and interposed between the seating block and the connecting member or the shell, like a washer. As one modification, as shown in FIG. 4, the seating block 2 may be provided with a metal casing 12 which covers a relatively wide region of an outer peripheral surface of the seating block 2 and includes a contact portion with the connecting member 3, wherein the contact portion (lower end) of the metal casing 12 may be clamped by the connecting member 3.

A seating block installation structure according to a fourth embodiment of the present invention will be described with reference to FIGS. 5(a) and 5(b).

The seating block installation structure according to the fourth embodiment is based on the seating block installation structure according to the first embodiment, and additionally configured such that a cover member 14 is provided above a region corresponding to a screw head of the connecting member 3 to prevent at least a part of the screw head from being exposed to the outside.

In the fourth embodiment, after installation and fixing of the seating block, an unshaped refractory material may be provided on an upper and/or outer peripheral sides of a joined portion of the seating block 2 on site, in the same manner as that in the second embodiment illustrated in FIG. 2. This is advantageous in allowing a refractory layer of the bottom portion of the molten metal vessel to be formed on an upper and/or outer peripheral sides of the seating block 2, without any space therebetween.

Particularly in the case where the unshaped refractory material is provided as mentioned above, the unshaped refractory material is directly and tightly filled and solidified in a region in which the connecting member 3 such as the screw head is supported and to be manipulated, leading to difficulty in disassembling. A cover such as the cover member 14 is provided to prevent such a situation. In the fourth embodiment, as shown in FIG. 5(b), the seating block 2 may have a concave portion formed at an upper end of the through-hole penetrating through the seating block 2 and receiving therein the connecting member 3, to surround the entire screw head of the connecting member.

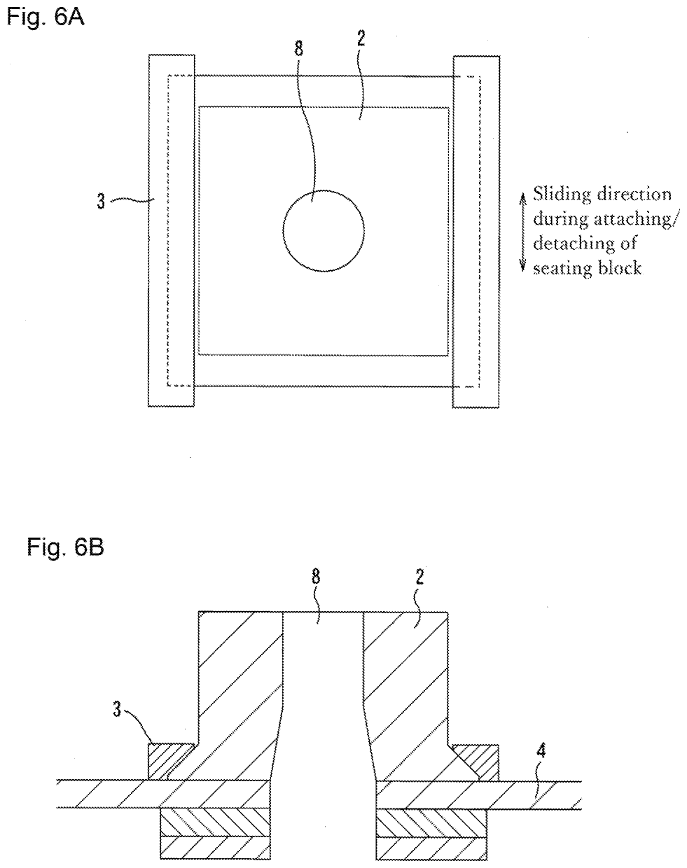

A seating block installation structure according to a fifth embodiment of the present invention will be described with reference to FIG. 6(a) to FIG. 12.

In the fifth embodiment, a cross-sectionally square-shaped seating block 2 has a portion expanding obliquely downwardly at least a part of a lower end thereof, and a connecting member 3 formed to have a surface conforming to an outer shape of the expanding portion of the seating block 2 is installed to a shell 4 of a bottom portion of a molten metal vessel in the form of a single piece or divided pieces arranged at a plurality of positions, such that at least a part of the seating block 2 is attached between the connecting member 3 and the shell 4 in a close contact manner, wherein a space defined between the connecting member 3 and the shell 4 is opened at least one direction along a region thereof corresponding to an outer periphery of the seating block 2. That is, in the fifth embodiment, the expanding portion of the seating block 2 is slidingly fitted into the space between the connecting member 3 and the shell 4, thereby fixing the seating block 2 to the shell 4.

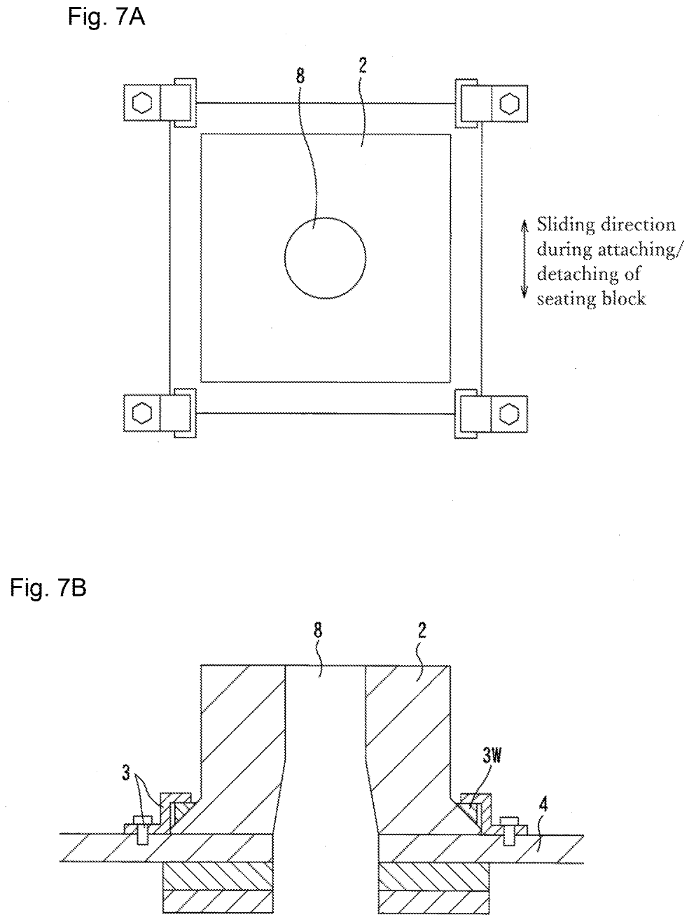

A joined portion of the connecting member 3 to the shell 4 may be one or more appropriately selected from the group consisting of a welded structure (FIGS. 6(a) and 6(b)), a thread engagement structure, in other words, screwed structure (FIGS. 7(a), 7(b), 8(a), 8(b), 9(a) and 9(b)), and a contact structure between the connecting member 3 and an outer surface of the shell 4 defining the periphery of an opening of a through-hole penetrating through the shell 4 (i.e., a contact structure between the outer surface of the shell 4 and the connecting member 3 such as a rivet or a bolt (in a set of bolt and nut) inserted in a through-hole penetrating between the outer surface of the molten metal vessel defined by the shell 4 and an inner surface of the shell 4, FIG. 10).

It should be understood that this structure using a combination of a through-hole and a rivet or a set of bolt and nut may be applied to not only the fifth embodiment but also the first to fourth embodiments

The seating block may be provided with a metal plate or casing or a sheet consisting mainly of an inorganic material or carbon. In this case, as shown in FIGS. 7(a) and 7(b), a wedge 3W may be attached to the expanding portion of the seating block 3 at a position between the connecting member 3 and the expanding portion to strengthen the fixing.

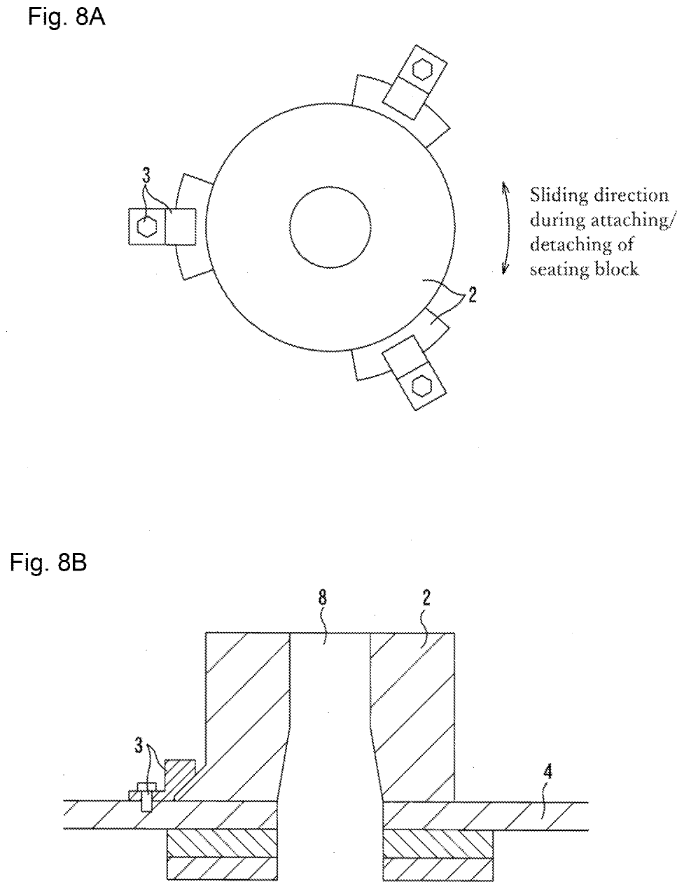

As one modification of the fifth embodiment, the seating block 2 may be formed in a cylindrical shape to have an expensing portion at least a part of a lower end thereof in the same manner as that described above, wherein the seating block 2 can be fixed to the shell 5 by: disposing the expanding portion between adjacent two of a plurality of connecting members 3; and rotating the seating block 2 to fittingly insert the expanding portion into a space defined between one of the connecting members 3 and the shell 4 (so-called “bayonet structure”, FIGS. 8(a) and 8(b)).

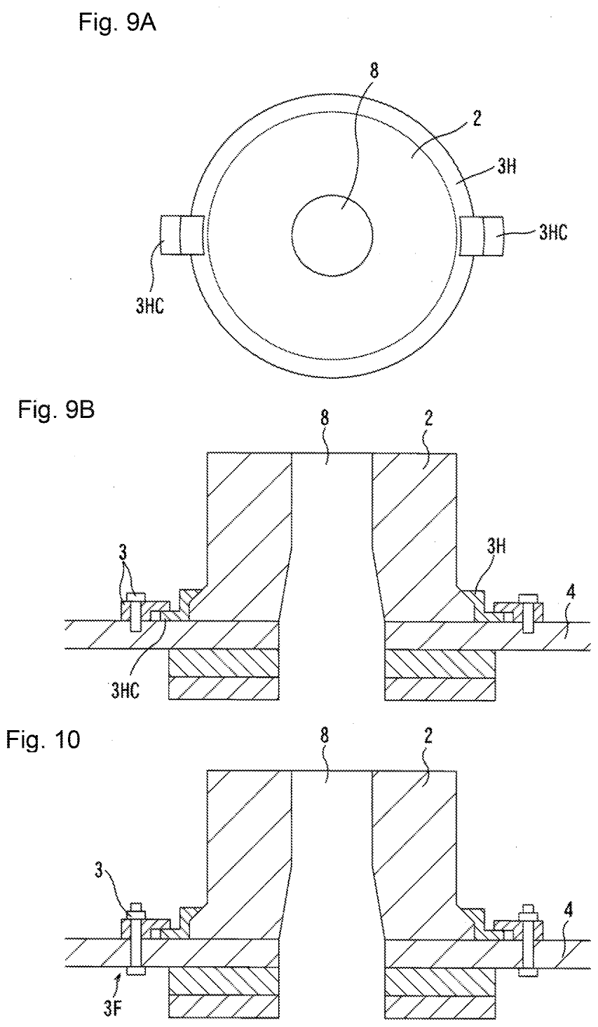

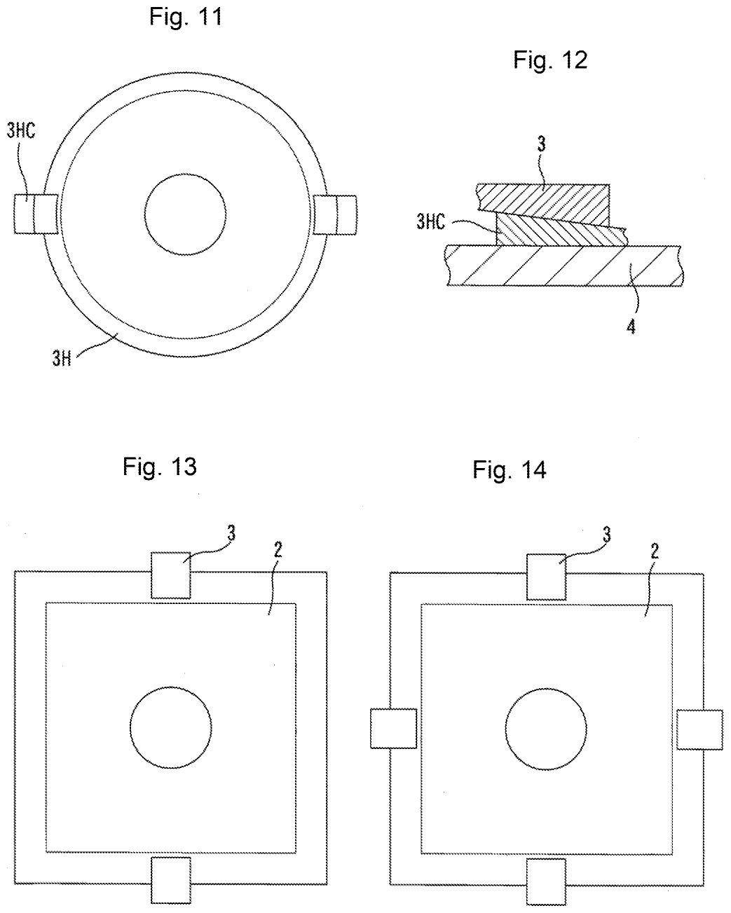

In the slidingly attaching type or the rotationally attaching type, a holder 3H as an independent component may be attached to the seating block 2 at a position between the seating block 2 and the connecting member 3 (FIGS. 9(a) and 9(b)). This holder 3H has a horizontally protruding portion 3HC at least in a region joinable to the connecting member 3, wherein the seating block 2 is fixed by slidingly or rotationally attaching the protruding portion 3HC to the connecting member 3 (FIGS. 11 and 12). In particular, a distance between the connecting member 3 and the protruding portion 3HC, or a thickness of the protruding portion 3HC, may be reduced in an attaching (sliding or rotation) direction. This makes it possible to gradually increase the strength of the fixing. Further, during disassembling, the seating block 2 can be easily detached by sliding or rotating the seating block 2 in the reverse direction.

It should be understood that the structure using such a holder 3H may be applied to any other suitable attaching type other than the slidingly and rotationally attaching types.

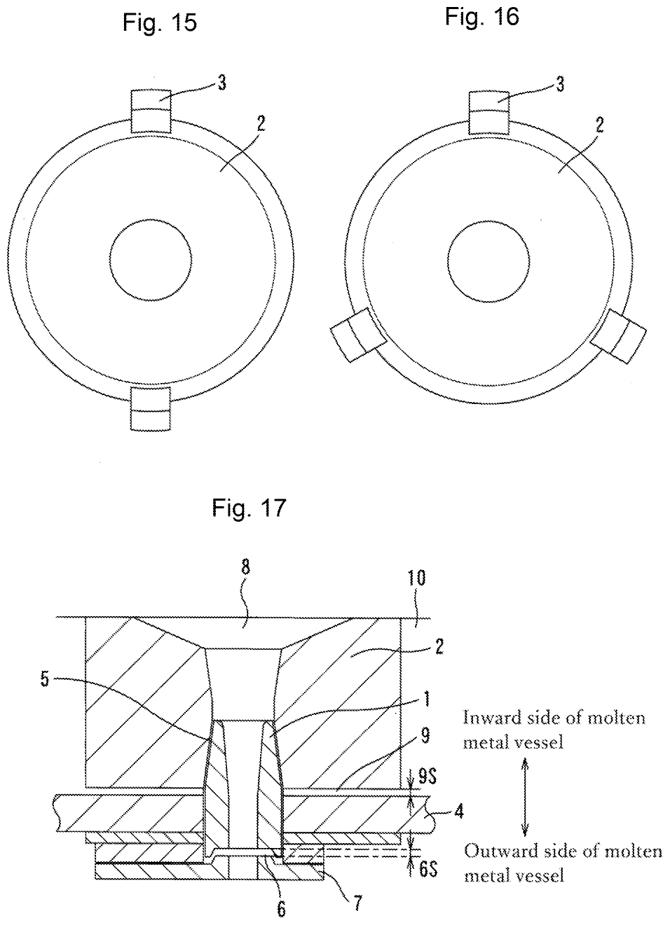

FIGS. 13 to 16 show various examples of installation positions of connecting members 3. As shown in FIGS. 13 to 16, the connecting member 3 (joining portion of the connecting member 3) preferably exists in a manner distributed at least two position equally dividing an outer periphery of the seating block 2.

Basically, the shell of the molten metal vessel is repeatedly used for a long period of time, and it is necessary to avoid degradation of the shell. Repetitive welding operations are undesirable because they become a factor causing deterioration of the shell and serious damage such as crack formation or breaking. Moreover, the repetitive operation of disassembly and welding is undesirable in terms of productivity and cost, because it requires a lot of time, effort and cost.

Therefore, in a case where the seating block installation structure includes welding to the shell, it is preferable to combinationally use fixing based on a detachable component with respect to the seating block, such as a thread engagement structure, in other words, screwed structure, a hooking structure, a sliding structure, a bayonet structure, etc., as mentioned above, so as not to repeat welding and disassembling.

### LIST OF REFERENCE SIGNS

1: upper nozzle
2: seating block
3: connecting member
3F: joined portion of connecting member to shell
3H: part of connecting member (in example where a holder or the like is disposed at a mid position)
3HC: protruding portion of holder in the above example
3W: part of connecting member (in example where a wedge or the like is disposed at a mid position)
4: shell of bottom portion of molten metal vessel
5: joint between upper nozzle and seating block
6: joint between upper nozzle and lower nozzle (e.g., plate)
6S: thickness of gap formed between upper nozzle and lower nozzle (e.g., plate)
7: lower nozzle
8: inner bore
9: gap formed between seating block and shell of bottom portion of molten metal vessel
9S: thickness gap 9
10: refractory layer (surroundings (peripheral region) of seating block)
11: unshaped refractory layer (surroundings (peripheral region) of seating block)
12: metal plate or metal casing
13: sheet material
14: cover member for connecting member

1. An installation structure for a seating block disposed to surround a nozzle for discharging therethrough molten metal downwardly from a bottom portion of a molten metal vessel, or a plug, wherein the seating block is fixed to a shell of the bottom portion of the molten metal vessel by a connecting member.

2. The installation structure as claimed in claim 1, wherein a joined portion of the connecting member to the shell has one or more selected from the group consisting of a welded structure, a thread engagement structure, and a contact structure between the connecting member and an outer surface of the shell defining a periphery of an opening of a through-hole penetrating through the shell.

3. The installation structure as claimed in claim 1, wherein a contact portion of the connecting member with the seating block is at least partly in contact with the seating block through one selected from the group consisting of a metal plate, a metal casing, and a sheet consisting mainly of an inorganic material or carbon.

4. The installation structure as claimed in claim 1, wherein the connecting member is composed of a plurality of independent members, wherein the independent members are configured to connect between the seating block and the shell, in a manner allowing assembling and disassembling by means of one or more selected from the group consisting of a thread engagement structure, a hooking structure, a fitting structure, a sliding structure, and a bayonet structure.

5. The installation structure as claimed in claim 1, wherein a joining portion of the connecting member exists in a manner distributed at least two positions equally dividing an outer periphery of the seating block.

6. The installation structure as claimed in claim 1, which is configured such that at least a part of the connecting member is covered so as not to be exposed to outside.

7. The installation structure as claimed in claim 1, which is configured such that an unshaped refractory material is provided in at least a part of a region on an upper or outer peripheral side of the connecting member.
